(19) United States
(12) Patent Application Publication
(10) Pub. No.: US 2014/0162172 A1
(43) Pub. Date: Jun. 12, 2014

(54) ELECTROLYTE MEMBRANE, PREPARING METHOD THEREOF, AND MEMBRANE ELECTRODE ASSEMBLY AND FUEL CELL INCLUDING THE MEMBRANE

(71) Applicant: SAMSUNG ELECTRONICS CO., LTD., Suwon-si (KR)

(72) Inventor: Manabu TAKEZAWA, Yokohama (JP)

(73) Assignee: SAMSUNG ELECTRONICS CO., LTD., Suwon-si (KR)

(21) Appl. No.: 14/103,950

(22) Filed: Dec. 12, 2013

(30) Foreign Application Priority Data
Dec. 12, 2012 (JP) 2012-271815
Aug. 30, 2013 (KR) 10-2013-0104515

(51) Int. Cl. H01M 8/10

(52) U.S. Cl. CPC H01M 8/1039; H01M 8/1072; H01M 8/1023
USPC 429/492; 521/27

(57) ABSTRACT

An electrolyte membrane including: a host polymer having a fluoropolymer molecular chain having a segment of the formula —CF₂—CF(M)CH₂—CF₂—, wherein M is at least one selected from —CF₃—, —CF₂H—, —CFH₂— and a combination thereof, the segment being defluorinated or dehydrofluorinated and chemically crosslinked by a low molecular weight basic compound having at least two amino groups; and a proton conductive polymer having a polymer chain being a co-polymerization product of a low molecular weight polymerizable proton conductor monomer including an acidic group having a dissociable proton and at least one polymerizable functional group, with a crosslinking agent; wherein the molecular chains of the host polymer and the proton conductive polymer form an interpenetrating polymer network.

### CROSS-REFERENCE TO RELATED APPLICATIONS

This application claims the benefit of Japanese Patent Application No. 2012-271815, filed on Dec. 12, 2012, in the Japanese Patent Office and Korean Patent Application No. 10-2013-0104515, filed on Aug. 30, 2013, in the Korean Intellectual Property Office, the disclosures of which are both incorporated herein in their entirety by reference.

### BACKGROUND

1. Field

The present disclosure relates to an electrolyte membrane and a method of preparing the electrolyte membrane, and a membrane electrode assembly and a fuel cell. More specifically, the present disclosure relates to an electrolyte membrane operable under high temperature and low humidity conditions, a method of preparing the electrolyte membrane, a membrane electrode assembly, and a fuel cell including the electrolyte membrane.

2. Description of the Related Art

Recently, fuel cells have been increasingly used in vehicles, residential cogeneration systems, and many other applications. To improve the distribution and utility of the fuel cells, there is a need for the development of an electrolyte membrane which can be operated under high temperatures, for example 100° C. or higher, and a non-humidified or low humidity condition, for example 50% relative humidity (RH) or lower.

When an electrolyte membrane with high proton conductivity is provided under the above conditions, a fuel cell system can be simplified, and thus the distribution and use of fuel cells in vehicles and residential cogeneration systems, etc. will be expedited.

Recently, various proposals have been provided regarding solid polymer electrolyte fuel cells (“PEFC”) which can operate at 100° C. or higher.

In general, since catalyst activation is improved where power generation is conducted at about 100° C. or more, it is suggested that the degree of poisoning due to carbon monoxide may be reduced. Further, it is thought that the lifetime of a fuel cell may be extended. However, since water molecules are unable to stably exist in a medium-temperature operation of about 150° C., fuel cells employing electrolytes which do not depend upon an aqueous medium for proton conduction, such as phosphoric acid-impregnated polybenzimidazole, e.g., as described in U.S. Pat. No. 5,525,436, have been suggested. It is thought that the foregoing fuel cell can generate power even in a medium temperature range of about 150° C.

However, in order to impregnate a strong acid such as phosphoric acid into a basic polymer membrane such as polybenzimidazole, it is necessary to perform a process of impregnating a basic polymer membrane with a large amount of the strong acid for a few hours or more, as described in JP Patent Application Publication No. 2012-124161. Further, after the impregnation, the acid in a liquid state that is attached to the surface of the electrolyte membrane should be removed. When the electrolyte membrane is manufactured in a large scale via after-impregnation (or after-doping) of an acid, the preparing process becomes inefficient, and thus it is required that the time for impregnation be reduced or the impregnation process itself be omitted. Additionally, in an electrolyte membrane where the acid in liquid state is impregnated, the acid may be exuded from the electrolyte membrane, and thus the amount of the phosphoric acid impregnated in the electrolyte membrane may not be uniform, and a storage property or the quality stability of the electrolyte membrane may be low.

In addition, as a conventional method of preparing an electrolyte membrane, an electrolyte membrane is manufactured by impregnating phosphoric acid into a membrane obtained by casting a polybenzimidazole polymer solution, where polybenzimidazole as a basic polymer solution is dissolved in an organic solvent.

There has also been proposed a method of impregnating a strong acid into a basic polymer membrane, wherein a low cost fluoropolymer, i.e., a fluorine-containing polymer, is crosslinked by a basic compound, as described in JP Patent Application Publication No. 2009-158373. However, it is difficult to control the amount of phosphoric acid in order to further improve the amount of impregnation of phosphoric acid so as to improve the proton conductivity.

Furthermore, when a polybenzimidazole (“PBI”) solution is mixed with phosphoric acid, there occurs a strong acid-base interaction because PBI is a strong base, thus gellation of the mixed solution occurs. In this case, it is difficult to manufacture a polymer membrane containing acid homogeneously.

Although JP Patent Application Publication No. 2010-508619 discloses a technology of polymerizing polymerizable acidic monomers to manufacture an electrolyte membrane, the technology is cumbersome because it requires polymerizing the polymerizable acidic monomers after impregnating the acidic monomers on a host polymer.

### SUMMARY

Provided is an electrolyte membrane for a fuel cell that can be operated under high temperature and low humidity conditions.

Provided also are a membrane electrode assembly and a fuel cell including the electrolyte membrane.

Provided also is a method of preparing an electrolyte membrane including the above characteristics.

According to an aspect of the present disclosure, there is provided an electrolyte membrane including:

a host polymer including a fluoropolymer molecular chain having a segment of the formula —CF₂—CF(M)CH₂—CF₂—, wherein M is at least one selected from —CF₃, —CF₂H, —CFH₂ and a combination thereof, the segment being defluorinated or dehydrofluorinated and chemically crosslinked by a low molecular weight basic compound having at least two amino groups; and

a proton conductive polymer having a polymer chain being a co-polymerization product of a low molecular weight polymerizable proton conductor monomer including an acidic group having a dissociable proton and at least one polymerizable functional group, with a crosslinking agent;

wherein the molecular chains of the host polymer and the proton conductive polymer form an interpenetrating polymer network (“IPN”).

In an embodiment of the present disclosure, the fluoropolymer may be at least one selected from vinylidene fluoride-hexafluoropropylene copolymer and vinylidene fluoride-hexafluoropropylene-tetrafluoroethylene terpolymer.

In an embodiment of the present disclosure, a carbon-carbon double bond (C═C) may be formed in the backbone of the molecular chain of the fluoropolymer.

In an embodiment of the present disclosure, the low molecular weight basic compound may be a heterocyclic compound having a nitrogen atom in the ring thereof. It can crosslink the molecular chains of the fluoropolymer. The heterocyclic compound having a nitrogen atom in the ring thereof has a site to interact with a polymerizable proton conductor.

In an embodiment of the present disclosure, the acidic group bound to the low molecular weight polymerizable proton conductor may be at least one selected from a phosphonic acidic group and a sulfonic acidic group. For example, the low molecular weight polymerizable proton conductor is at least one selected from vinyl phosphonic acid, vinyl sulfonic acid, and 2-acrylamide-2-methylpropane sulfonic acid.

In an embodiment of the present disclosure, the crosslinking agent that crosslinks the polymer molecular chains produced from the polymerization of the polymerizable proton conductor may have at least one radical-polymerizable functional group selected from an acrylic group, a methacrylic group, a vinyl group, an allyl group, a methallyl group, a phenylvinyl group, a vinylether group, an acrylate group, and a methacrylate group.

According to another aspect of the present disclosure, there is provided a membrane electrode assembly including a cathode, an anode, and an electrolyte membrane located between the cathode and the anode, wherein the electrolyte membrane is an electrolyte membrane according to an aspect of the present disclosure.

According to a further aspect of the present disclosure, there is provided a fuel cell including the membrane electrode assembly according to another aspect of the present disclosure.

The electrolyte membrane according to an aspect of the present disclosure may be prepared by a method described in detail herein below, which includes preparing of a one-pot mixed solution containing a fluoropolymer, a low molecular weight basic compound, a low molecular weight polymerizable proton conductor, and a crosslinking agent for crosslinking the proton conductor;

performing a first crosslinking in which the fluoropolymer and the low molecular weight basic compound contained in the mixed solution are crosslinked; and

performing a second crosslinking in which the low molecular weight polymerizable proton conductor is crosslinked while being polymerized.

That is, according to a further aspect of the present disclosure, a method of preparing an electrolyte membrane, the method including:

reacting, in an organic solvent, a fluoropolymer having a segment of the formula —CF₂—CF(M)CH₂—CF₂—, wherein M is one selected from —CF₃, —CF₂H, and —CFH₂, and a combination thereof, with a low molecular weight basic compound having at least two amino groups to form a carbon-carbon double bond (C═C) in the fluoropolymer; and

preparing a mixed solution including

a low molecular weight polymerizable proton conductor monomer which has an acidic group having a dissociable proton and a polymerizable functional group, and

a crosslinking agent which crosslinks the low molecular weight polymerizable proton conductor monomer;

removing the organic solvent from the mixed solution to provide a precipitate;

performing a first crosslinking of the fluoropolymer with the low molecular weight basic compound contained in the precipitate to provide a crosslinked fluoropolymer; and

co-polymerizing the low molecular weight polymerizable proton conductor contained in the precipitate with the crosslinking agent to provide a polymerized product of the low molecular weight proton conductor; and

performing a second crosslinking of the polymerized product of the low molecular weight proton conductor and the crosslinked fluoropolymer to provide an interpenetrating polymer network.

In an embodiment of the present disclosure, the second crosslinking may be performed by applying an electron beam, UV light, γ rays, and heat to the precipitate.

In an embodiment of the present disclosure, the fluoropolymer may be at least one selected from vinylidene fluoride-hexafluoropropylene copolymer and vinylidene fluoride-hexafluoropropylene-tetrafluoroethylene terpolymer.

In an embodiment of the present disclosure, the low molecular weight basic compound may be a heterocyclic compound having a nitrogen atom in the ring thereof.

In an embodiment of the present disclosure, the acidic group of the low molecular weight polymerizable proton conductor may be at least one selected from a phosphonic acidic group and a sulfonic acidic group. For example, the low molecular weight polymerizable proton conductor may be at least one selected from vinyl phosphonic acid, vinyl sulfonic acid, and 2-acrylamide-2-methylpropane sulfonic acid.

In an embodiment of the present disclosure, the crosslinking agent may be at least one radical-polymerizable functional group selected from an acrylic group, a methacrylic group, a vinyl group, an allyl group, a methallyl group, a phenylvinyl group, a vinylether group, an acrylate group, and a methacrylate group.

In an embodiment of the present disclosure, the polymerizing and the second crosslinking may be performed simultaneously.

According to a further aspect of the present disclosure, there is provided a membrane electrode assembly including an anode; a cathode; and the electrolyte membrane described herein disposed between the anode and the cathode.

According to a further aspect of the present disclosure, there is provided a fuel cell membrane electrode assembly including the membrane electrode assembly described herein.

The electrolyte membrane manufactured by the method, though not limited thereto, may be appropriately used in PEFC such as solid polymer electrolyte membrane.

As described above, according to the one or more of the above embodiments of the present disclosure, an electrolyte membrane, which is operable under the conditions of a temperature of 100° C. or higher and 50% RH or below, and enables control of the uniformity of the amount of ion conductors, can be conveniently prepared. Accordingly, the thus-prepared electrolyte membrane has excellent proton conductivity and effectively prevents leakage from the electrolyte membrane of acid which is immobilized by polymerization, thus providing long term storage stability.

In addition, according an embodiment of the present disclosure, the method of preparing the electrolyte membrane by using pre-impregnation of an acid component prevents gellation of the acid-containing polymer solution while uniformly maintaining the acid component in the electrolyte membrane during the preparing process, thereby providing improved electrolyte membrane characteristics as compared to electrolyte membranes prepared by the conventional after-impregnation (after-doping) method, with a smaller number of processing steps and a reduced cost.

### DETAILED DESCRIPTION

Reference will now be made in detail to embodiments. In this regard, the present embodiments may have different forms and should not be construed as being limited to the descriptions set forth herein. Accordingly, the embodiments are merely described below to explain aspects of the present disclosure. As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “mixture” is inclusive of all types of combinations, including physical mixtures, blends, alloys, solutions, and the like.

Hereinafter, an electrolyte membrane, a membrane electrode assembly (“MEA”) and a fuel cell including the electrolyte membrane, according to embodiments of the present disclosure, are described.

An electrolyte membrane according to an embodiment of the present disclosure includes: a host polymer having a molecular structure in which the molecular chain of a fluoropolymer having at least a segment of the formula —CF₂—CF(M)CH₂—CF₂—, wherein M is one selected from —CF₃, —CF₂H, and —CFH₂, is chemically crosslinked by a low molecular weight basic compound having at least two amino groups; and a proton conductive polymer having a molecular structure in which a polymer chain obtained by polymerization of a low molecular weight polymerizable proton conductor which has an acidic group, at least one polymerizable functional group, and is capable of dissociating proton, is chemically crosslinked by a crosslinking agent. The molecular chains of the host polymer and the molecular chains of the proton conductive polymer are interlaced one another to form an interpenetrating polymer network. In other words, the electrolyte membrane may comprise: a host polymer comprising a defluorinated or dehydrofluorinated, then crosslinked, product of a fluoropolymer comprising a segment of the formula —CF₂—CF(M)CH₂—CF₂—, wherein M is at least one selected from —CF₃, —CF₂H, and —CFH₂, and a low molecular weight basic compound having at least two amino groups; and a proton conductive polymer comprising a co-polymerization product of a low molecular weight polymerizable proton conductor monomer comprising an acidic group having a dissociable proton and at least one polymerizable functional group, with a crosslinking agent; wherein the host polymer and the proton conductive polymer form an interpenetrating polymer network.

The fluoropolymer is at least one selected from vinylidene fluoride-hexafluoropropylene copolymer and vinylidene fluoride-hexafluoropropylene-tetrafluoroethylene terpolymer. A carbon-carbon double bond (C═C) is formed in the backbone of the molecular chain of the fluoropolymer by reaction with a low molecular weight basic compound.

The low molecular weight basic compound having at least two amino groups is involved in crosslinking of the molecular chains of the fluoropolymer, and may be a heterocyclic compound having a nitrogen atom in the ring thereof. The heterocyclic compound having a nitrogen atom in the ring thereof has a site to interact with a polymerizable proton conductor.

The acidic group binding to the low molecular weight polymerizable proton conductor may be at least one selected from a phosphonic acidic group and a sulfonic acidic group. The low molecular weight polymerizable proton conductor may be, for example, at least one selected from vinyl phosphonic acid, vinyl sulfonic acid, and 2-acrylamide-2-methylpropane sulfonic acid.

The crosslinking agent involved in the crosslinking of the polymer molecular chains obtained by the polymerization of the polymerizable proton conductor may have at least one radical-polymerizable functional group selected from an acrylic group, a methacrylic group, a vinyl group, an allyl group, a methallyl group, a phenylvinyl group, a vinylether group, an acrylate group, and, a methacrylate group. In particular, the crosslinking agent may have at least two, three, or four radical-polymerizable functional groups selected from an acrylic group, a methacrylic group, a vinyl group, an allyl group, a methallyl group, a phenylvinyl group, a vinylether group, an acrylate group, and a methacrylate group.

The MEA according to another aspect of the present disclosure includes a cathode, an anode, and an electrolyte membrane located between the cathode and the anode, wherein the electrolyte membrane is an electrolyte membrane according to an aspect of the present disclosure.

In particular, the MEA has a structure wherein the electrolyte membrane is interposed between the cathode and the anode. The cathode may be an oxidizing agent electrode, and the anode may be a fuel electrode. Each electrode is an electrode that contacts an oxidizing agent gas or a fuel gas that is supplied when a fuel cell is under operation, and any electrode obtained by a known technology may be used.

Regarding the preparing of an MEA by using electrodes and an electrolyte membrane, any method in which an electrolyte membrane can be disposed between the cathode and the anode may be used. In order to improve adhesion between the electrodes and the electrolyte membrane, it may be desirable to apply pressure in the direction of the membrane surface of the MEA.

According to another aspect of the present disclosure, there is provided a fuel cell having at least one MEA as described above.

According to a method for preparing the electrolyte membrane of the present disclosure, a mixed solution, which includes at least a fluoropolymer, a low molecular weight basic compound, a low molecular weight polymerizable proton conductor, and a crosslinking agent, and has been previously prepared as one pot solution, is used. As starting materials, a low molecular weight basic compound and a polymerizable proton conductor may be used by dissolving them in an organic solvent in advance to thereby prevent gellation of the raw material solution.

The fluoropolymer used in the present disclosure can have the segment of the formula —CF₂—CF(M)CH₂—CF₂— in a backbone thereof or pendent from the backbone. Other polymer segments can be present, for example groups of the formula —CCl₃, —CCl₂H, and —CClH₂. In an embodiment, the fluoropolymer contains only groups of the formulas —CH₂—, —CF₃, —CF₂H, and —CFH₂. For example, the fluoropolymer may have at least a —CF₂—CF(M)CH₂—CF₂— structure wherein M is at least one selected from —CX₃—, —CX₂H—, and —CXH₂—, and X is F. The fluoropolymer may be at least one selected from vinylidene fluoride-hexafluoropropylene copolymer (PVdF-HFP) and vinylidene fluoride-hexafluoropropylene-tetrafluoroethylene terpolymer. In particular, the fluoropolymer may be PVdF-HFP.

The basic compound used in the present disclosure is a low molecular weight compound and has at least two amino groups. The basic compound may have a molecular weight that would not cause gellation of the mixed solution of starting materials, and desirably have a molecular weight of monomer or oligomer in a range of about 2,000 Daltons or less, for example about 60 to about 2,000 Daltons, or about 70 to about 1,500 Daltons, or about 80 to about 1,000 Daltons, or about 80 to about 500 Daltons. By mixing the low molecular weight basic compound with other starting materials, the gellation of the mixed solution can be prevented.

In addition, the low molecular weight basic compound used in the present disclosure has at least two amino groups. In particular, a heterocyclic compound having a nitrogen atom in its ring structure may be used. The heterocyclic compound having a nitrogen atom in its ring structure has a site to interact with the polymerizable proton conductor further added to the mixed solution. Accordingly, the electrolyte membrane obtained according to the preparing method of the present disclosure may retain at least 500 parts by weight of an acid based on 100 parts by weight of the total amount of the fluoropolymer and the basic compound.

The low molecular weight basic compound, though not limited thereto, may include, for example, diamino imidazole and its derivatives, diamino triazine and its derivatives, diamino triazole and its derivatives, diamino pyridine and its derivatives, and diaminobenzimidazole and its derivatives.

The amount of the low molecular weight basic compound may be in a range from about 10 to 35 parts by weight based on 100 parts by weight of the fluoropolymer, for example, in a range from about 20 to 30 parts by weight.

The fluoropolymer and the low molecular weight basic compound may be respectively dissolved in an organic solvent and then mixed, or may be combined in an organic solvent. The fluoropolymer and the low molecular weight basic compound are mixed and then allowed to react at a temperature below the boiling point of the organic solvent. The reaction temperature may vary depending on the organic solvent used, and may be in a range from about 80° C. to about 150° C. In addition, when a reflux device is installed during the reaction process, the reaction temperature may be above the boiling point of the organic solvent, and by which the reaction may be accelerated to thereby reduce the reaction time.

In the reaction between the fluoropolymer and the low molecular weight basic compound, a defluorination or dehydrofluorination may occur, that is, the binding state of the fluoropolymer may change in the presence of the low molecular weight basic compound, thereby forming a carbon-carbon double bond (C═C) in the main chain of the fluoropolymer. It is considered that the carbon-carbon double bond portion and a nitrogen atom in the amino group bound to the basic compound are bound by heat treatment performed later to thereby form a crosslinked structure between the fluoropolymer and the low molecular weight basic compound. Accordingly, the more the carbon-carbon double bonds, the easier the crosslinking.

The organic solvent for the reaction between the fluoropolymer and the low molecular weight basic compound may not be particularly limited as long as it can sufficiently dissolve the fluoropolymer and the low molecular weight basic compound. Each starting material may be mixed in a dissolved state, or in an organic solvent. When the starting materials are mixed in a dissolved state, it is desirable to use solvents which have compatibility between them. Examples of the organic solvents to be used in the present disclosure, though not limited thereto, may include an ester-based solvent such as N-methylpyrrolidone (“NMP”), N,N-dimethyl formamide (“DMF”), dimethyl sulfoxide (“DMSO”), dimethyl acetamide (“DMAc”), ethyl acetate, etc.; a ketone-based solvent such as acetone, ethyl methyl ketone, etc.; or combinations thereof. Mixing may be by any means known in the art.

The reaction time between the fluoropolymer and the low molecular weight basic compound may be in a range from about 20 hours to about 10 hours, for example, about 50 hours to about 100 hours. The longer the reaction time, the more the carbon-carbon double bonds, thus making it easier to increase the crosslinking density. However, when the reaction time exceeds about 150 hours, an excessive crosslinking may occur, and thus the membrane structure obtained therefrom may lack flexibility. In contrast, when the reaction time is less than about 20 hours, the crosslinking density may be low, and thus, the membrane may lack a thermal resistance at a high temperature condition, thus it is not desirable.

Upon completion of the reaction process, to the mixed solution containing the fluoropolymer having a carbon-carbon double bond in the main chain and the low molecular weight basic compound is added a low molecular weight polymerizable proton conductor and a crosslinking agent which crosslinks the low molecular weight polymerizable proton conductor, and mixes them until the mixture becomes homogeneous.

In order to retain a large amount of acid in the membrane structure formed in the subsequent crosslinking process, it is desirable that the polymerizable proton conductor and the crosslinking agent be added to the mixed solution after forming of a carbon-carbon double bond in the main chain of the fluoropolymer. However, when the amount of the carbon-carbon double bonds formed in the main chain of the fluoropolymer is sufficiently present to provide a desirable proton conductivity, the order of adding the fluoropolymer, the low molecular weight basic compound, the low molecular weight polymerizable proton conductor and its crosslinking agent are not limited.

The polymerizable proton conductor used in the present disclosure is a low molecular weight compound, has an acidic group and at least one polymerizable functional group, and is also capable of dissociating proton.

The low molecular weight basic compound and the polymerizable proton conductor monomer may have a molecular weight that would not cause gellation of the mixed solution of starting materials, and in particular, have a molecular weight of monomer or oligomer in a range of about 2,000 Daltons or less. In particular, the polymerizable proton conductor monomer may have a molecular weight of about 40 to about 2,000 Daltons, or about 60 to about 1,500 Daltons, or about 80 to about 1,000 Daltons, or about 80 to about 500 Daltons.

In addition, the polymerizable proton conductor monomer may have an acidic group and at least one polymerizable functional group. That is, the polymerizable proton conductor has, in its molecular structure, a functional group capable of forming a bond between atoms by an addition reaction or a condensation reaction, such as a carbon-carbon double bond, a carbon-carbon triple bond, a carbon-nitrogen double bond, an epoxy ring, a hydrogen radical, a carboxyl group, an amino group, an aldehyde group, etc.; and an acidic group which can dissociate hydrogen atoms as protons, such as a sulfonic acidic group, a phosphoric acidic group, a carboxylic acidic group, a hydroxyl group, etc. The examples include, though not limited thereto, vinyl phosphonic acid, vinyl sulfonic acid, and 2-acrylamide-2-methylpropane sulfonic acid. In the present disclosure, the polymerizable proton conductors may be used alone or in combination thereof.

The amount of the polymerizable proton conductor to be added in the present disclosure may be in a range from about 300 parts by weight to about 500 parts by weight based on 100 parts by weight of the total amount of the fluoropolymer and the low molecular weight basic compound, for example, from about 400 parts by weight to about 500 parts by weight.

As a crosslinking agent for crosslinking the polymerizable proton conductor, a crosslinking agent having a radical-polymerizable functional group may be used. The examples of the radical-polymerizable functional group, though not limited thereto, may be an acrylic group, a methacrylic group, a vinyl group, an allyl group, a methallyl group, a phenylvinyl group, a vinylether group, an acrylate group, or a methacrylate group. The crosslinking agent that has a polymerizable double bond may be used without limitation. In addition, it is desirable that the crosslinking agent have at least two vinyl groups within the molecule. The crosslinking agent may include, for example, though not limited thereto, poly(ethylene glycol)dimethacrylate (“PEGDM”), bis[2-(methacryloyloxy) ethyl]hydrogen phosphate, triallyl isocyanurate (“TAIC”), trimethallyl isocyanurate (“TMAIC”), trimethylolpropane trimethacrylate (“TMPTMA”), pentaerythritol tetraacrylate, di(trimethylolpropane)tetraacrylate, zirconium acrylate, etc. The crosslinking agent may be used alone or as a mixture of more than two compounds.

The amount of the crosslinking agent to be added in the present disclosure may vary depending on the types of the polymerizable proton conductor and the crosslinking agent. The amount of the polymerizable proton conductor may be in a range from about 300 parts by weight to about 500 parts by weight based on 100 parts by weight of the total amount of the fluoropolymer and the low molecular weight basic compound, and the amount of the crosslinking agent may be in a range from about 5 parts by weight to about 30 parts by weight based on the parts by weight of the polymerizable proton conductor.

The organic solvent for the mixed solution prepared in the present disclosure may not be particularly limited as long as it can sufficiently dissolve the fluoropolymer, the low molecular weight basic compound, the polymerizable proton conductor, and the crosslinking agent. Each starting material may be mixed in a dissolved state, or in an organic solvent. When the starting materials are mixed in a dissolved state, it is desirable to use solvents which have compatibility between them.

Examples of the organic solvents to be used in the present disclosure, though not limited thereto, may include an ester-based solvent such as N-methylpyrrolidone (“NMP”), N,N-dimethyl formamide (“DMF”), dimethyl sulfoxide (“DMSO”), dimethyl acetamide (“DMAc”), ethyl acetate, etc.; a ketone-based solvent such as acetone, ethyl methyl ketone, etc.; or combinations thereof.

The mixed solution to be used in the present disclosure is prepared by adding at least the fluoropolymer, the low molecular weight basic compound, the polymerizable proton conductor, and the crosslinking agent in the organic solvent, and agitating them until they are homogeneously mixed. The method of agitation may include, though not limited thereto, using a known mixer such as a homogenizer, a screw agitator, a magnetic stirrer, etc. Other components in addition to the starting materials may be added within a range that does not harm the effect of the present disclosure.

After casting the mixed solution on a substrate and drying at 150° C. for about an hour, the organic solvent is removed to obtain a precipitate. Examples of the substrate may include a glass substrate, a polyethylene terephthalate (“PET”) film, a polyimide film such as those film sold under the registered trademark KAPTON, etc. By drying the mixed solution on the substrate, a membranous precipitate, i.e., a precipitate in the shape of a membrane, without self-standing capability may be obtained.

A first crosslinking is performed by subjecting the membranous precipitate to a heat treatment. In the first crosslinking process, a basic compound is crosslinked to the carbon-carbon double bond included in the main chains of the fluoropolymer. The heat treatment may be performed at a temperature in a range from about 150° C. to about 220° C., for example, from about 180° C. to about 200° C. The time for a heat treatment may be in a range from about 60 minutes to about 180 minutes, for example, from about 90 minutes to about 120 minutes.

After the first crosslinking, a second crosslinking is performed to further crosslink the first crosslinked structure. In the second crosslinking, the polymerizable proton conductor or its polymerized products within the first crosslinked fluoropolymer structure is crosslinked along with the polymerization of the polymerizable proton conductor. After the second crosslinking, a self-standing electrolyte membrane may be obtained.

In the second crosslinking, any method which can radically polymerize the polymerizable proton conductor can be used without limitation. Examples of the method may include irradiation of an actinic ray such as an electron beam, UV or infrared light, heat, etc. In particular, when the irradiation is performed via the electron beam, the second crosslinking process may be completed within a short period of time. In addition, a homogeneous mixed solution can be easily prepared because a polymerization initiator is not needed.

When the electron beam is irradiated, an electron beam irradiating device with an acceleration voltage in a range from about 10 kV to about 1000 kV, for example, from about 30 kV to about 300 kV, may be used. The dosage of the electron beam may be in a range from about 5 kGy to about 200 kGy, for example, from about 10 kGy to about 100 kGy. When the dosage of the electron beam is less than 5 kGy, it may be difficult to obtain a self-standing electrolyte membrane. In contrast, when the dosage of the electron beam exceeds 200 kGy, the flexibility of the electrolyte membrane may be deteriorated.

In the present disclosure, starting materials are made into a one-pot solution by mixing them until the mixture becomes homogeneous. The precipitate obtained from the mixed solution is stepwise crosslinked in order to obtain a homogeneous electrolyte membrane.

In the present disclosure, the mixed solution before crosslinking contains a polymerizable proton conductor and thus it is easy to control the acid content in the electrolyte membrane composition. As described above, the solution preparation is completed in a single step and, thus, the so-called process of after-impregnation or after-doping of a doping acid is not necessary. Accordingly, the method of the present disclosure enables to simplify the preparing process of an electrolyte membrane and reduce the time required for manufacture.

Additionally, since the polymerizable proton conductor is immobilized by polymerization and the crosslinked structure, the electrolyte membrane obtained by the method provides excellent storage stability. In particular, the method enables to effectively suppress the leakage of acid from the electrolyte membrane during the operation of a fuel cell, and thus the fuel cell using the electrolyte membrane provides a long-term stability.

The electrolyte membrane obtained by the method of the present disclosure including the preparing processes described above is a self-standing electrolyte membrane having a thickness in a range from about 10 μm to about 200 μm. It is considered that, in the electrolyte membrane, a polymerized product derived from the polymerizable proton conductor and the crosslinked structure of the polymerized product are interlaced with the crosslinked structure formed by the fluoropolymer and the low molecular weight basic compound, thereby forming an interpenetrating polymer network (IPN). The electrolyte membrane is operable under the conditions of a temperature of 100° C. or higher and a humidity of 50% RH or below.

The electrolyte membrane obtained by the method of the present disclosure may be suitably used in a fuel cell. When the electrolyte membrane is used in a fuel cell, a cathode electrode is assembled at one end of the electrolyte membrane while an anode electrode is assembled at the opposite end of the electrolyte membrane, thereby forming an MEA. As the electrodes, one in which a catalyst layer is laminated on a porous product such as carbon may be used. Hydrogen is supplied to an anode as a fuel, whereas an oxidizing agent, such as air or oxygen gas, is supplied to a cathode, for example.

### EXAMPLES

Reference will now be made to examples and comparative examples to further explain the present disclosure in detail. The present examples are presented for an illustrative purpose only and the present disclosure should not be construed as being limited to the present examples set forth herein.

### Example 1

12 g of PVdF-HFP and 4 g of 6,4′-diamino-2-phenylbenzimidazole (“DAPBz”) were dissolved in a DMF solvent to prepare a 20 wt % solution, respectively. As the PVdF-HFP, KYNAR2801 (a weight average molecular weight of about 406,000) from ARKEMA was used. The PVdF-HFP solution in DMF and the DAPBz solution in DMF were mixed and reacted in the DMF solvent. The reaction was performed at about 130° C. for about 100 hours.

Upon completion of the reaction, the DMF solution was allowed to cool down to about 25° C., and added 400 parts by weight of vinyl phosphonic acid (VPA) (TOKYO CHEMICAL INDUSTRY Co., Ltd.) based on 100 parts by weight of the total amount of the PVdF-HFP and the DAPBz, and 10 parts by weight of PEGDM (Aldrich) were added based on the 400 parts by weight of the VPA. The mixture was agitated until all components were dissolved and a homogeneously mixed solution was obtained.

The homogeneously mixed solution thus obtained was cast on a glass substrate, and DMF was removed from the solution by heating for about 1 hour at about 150° C. and a membranous precipitate was obtained.

The precipitate on the glass substrate was subjected to a heat treatment at about 180° C. for about 90 minutes. The resultant film was exposed to electron beam irradiation (about 250 kV, about 50 kGy) and a self-standing electrolyte membrane having a thickness of about 50 μm was prepared.

### Example 2

The electrolyte membrane was manufactured in the same manner as in Example 1 except that 500 parts by weight of VPA were added based on 100 parts by weight of the total amount of the PVdF-HFP and the DAPBz.

### Comparative Example 1

A 10 wt % DMAc solution of polybenzimidazole (“PBI”) was prepared. The electrolyte membrane was prepared in the same manner as in Example 1 by adding 400 parts by weight of the VPA based on 100 parts by weight of PBI, and 10 parts by weight of PEGDM per 400 parts by weight of the VPA, and mixing thereafter. However, the mixed solution was gelled and thus the electrolyte membrane could not be prepared.

### Comparative Example 2

A 10 wt % DMAc solution of PBI was prepared and used as a PBI polymer cast solution. The PBI polymer cast solution was cast on a glass substrate, DMF was removed from the solution by heating for about 1 hour at about 150° C. and a PBI film was obtained. Then, a dope (a solution for impregnating the polymerizable proton conductor) was prepared by adding 100 parts by weight of VPA, and 10 parts by weight of PEGDM and 20 parts by weight of water based on 100 parts by weight of VPA. Then, a PBI film cut into a size of about 5 cm×about 5 cm was dipped into the dope at about 80° C. for about 5 hours, and the impregnated membrane was taken out and its surface was wiped out. The impregnated membrane was dried at about 60° C. for about 1 hour, exposed to electron beam irradiation (250 kV, 50 kGy), and an electrolyte membrane containing 400 parts by weight of VPA per the PBI film having a thickness of about 65 μm prepared via after-impregnation of acid was obtained.

### Method of Measuring Proton Conductivity

The electrolyte membranes obtained in Examples 1-2, and Comparative Example 2 were punched at a size of about 5 mm×about 30 mm, inserted into a carbon cloth electrode, respectively, and the thus-obtained structures were integrated into a cell for measuring conductivity by using platinum as an electrode.

The device used for measuring conductivity was MTS740 (Membrane Test System, Scribner Associate, Inc., U.S.A.). The temperature was increased to about 150° C. within a constant temperature bath with controlled humidity. Dry gas and 100% humidification (bubbler humidification) were mixed to control the pressure inside the constant temperature bath and generate a humidified gas with a predetermined relative humidity to be supplied to the constant temperature bath. Humidity was monitored by using a humidifier HMT310 (VAISALA). The gas supplied was N₂ gas. Humidity was increased from 0% RH to 40% RH at 20% RH intervals. When the humidity reached the respective predetermined RH, the humidity was maintained for about 90 minutes, and proton conductivity was measured via an A.C. Impedance technique. The results are shown in Table 1 below.

TABLE 1

| | Homogeneity | Proton Conductivity (mS/cm) | | |
|---|---|---|---|---|
| | of acid- | Relative | Relative | Relative |
| | containing | Humidity | Humidity | Humidity |
| | solution | (RH 0%) | (RH 20%) | (RH 40%) |
| Example 1 | good | 16.5 | 30 | 64 |
| Example 2 | good | 21 | 40 | 70 |
| Comparative | gellation | No | No | No |
| Example 1 | | membrane | membrane | membrane |
| | | formed. | formed. | formed. |
| | | Not | Not | Not |
| | | measurable. | measurable | measurable |
| Comparative | — | 8 | 19 | 28 |
| Example 2 | | | | |

### Method of Evaluating Chemical Durability (OCV Durability Test)

An MEA was prepared by using the electrolyte membrane prepared in Example 1 and its maintenance capability of Open Circuit Voltage (OCV) was evaluated as shown below.

First, a catalyst layer including carbon powders on which a catalyst was supported was laminated on top of a carbon porous substrate and used as a porous electrode for a fuel cell. As the catalyst, a platinum cobalt-supported catalyst (about 32 wt % of platinum content) in which a platinum cobalt alloy was supported on carbon powders (VULCAN XC72) was used. In particular, the two porous electrodes were laminated on both sides of the electrolyte membrane obtained in Example 1, and a fluid distribution plate for an oxidizing agent and a fluid distribution plate for fuel were disposed on the outside of each electrode to thereby prepare a fuel cell.

For the fuel cell thus prepared, hydrogen gas was supplied as a fuel while oxygen gas was supplied as an oxidizing agent at the same time. The back pressure for both hydrogen and oxygen gases were set at atmospheric pressure, and the change in time in OCV under a condition of about 130° C. of the fuel cell and about 20% RH for both hydrogen and oxygen gases were measured. The results are shown in Table 2 below.

TABLE 2

Open Circuit Maintenance Time (hr)

| | 0 | 500 | 1,000 | 1,500 |
|---|---|---|---|---|
| Voltage (mV) | 938 | 941 | 938 | 947 |

The electrolyte membranes prepared in Examples 1 and 2 consist of a crosslinked structure which is prepared by a process in which the fluoropolymer and the low molecular weight basic compound are allowed to react for a predetermined period of time, and to the reaction solution is added in advance the low molecular weight polymerizable proton conductor and the crosslinking agent to obtain a mixed solution, and the polymerization and crosslinking of the components of the mixed solution occur to obtain the targeted crosslinked structure. Accordingly, as shown in Tables 1 and 2, it is possible to easily control the acid amount as an acid impregnation method without using after-impregnation and also it is possible to prepare the homogeneous acid-containing polymer solution. Additionally, the thus-prepared electrolyte membranes provide excellent proton conductivity and chemical durability under conditions of high temperature of 100° C. or higher and low humidity.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present disclosure have been described, it will be understood by those of ordinary skill in the art that various changes in form and details may be made therein without departing from the spirit and scope of the present disclosure as defined by the following claims.

What is claimed is:

1. An electrolyte membrane comprising:
a host polymer comprising a fluoropolymer molecular chain comprising a segment of the formula, —CF₂—CF(M)CH₂—CF₂—, wherein M is at least one selected from —CF₃, —CF₂H, —CFH₂ and a combination thereof, the segment being defluorinated or dehydrofluorinated and chemically crosslinked by a low molecular weight basic compound having at least two amino groups; and
a proton conductive polymer comprising a polymer chain being a co-polymerization product of a low molecular weight polymerizable proton conductor monomer comprising an acidic group having a dissociable proton and at least one polymerizable functional group, with a crosslinking agent;
wherein the molecular chains of the host polymer and the proton conductive polymer form an interpenetrating polymer network.

2. The electrolyte membrane according to claim 1, wherein the fluoropolymer is at least one selected from vinylidene fluoride-hexafluoropropylene copolymer and vinylidene fluoride-hexafluoropropylene-tetrafluoroethylene terpolymer.

3. The electrolyte membrane according to claim 1, wherein a carbon-carbon double bond (C═C) is formed in the backbone of the molecular chain of the fluoropolymer.

4. The electrolyte membrane according to claim 1, wherein the low molecular weight basic compound is a heterocyclic compound having a nitrogen atom in the ring thereof.

5. The electrolyte membrane according to claim 1, wherein the acidic group bound to the low molecular weight polymerizable proton conductor is at least one selected from a phosphonic acidic group and a sulfonic acidic group.

6. The electrolyte membrane according to claim 1, wherein the low molecular weight polymerizable proton conductor is at least one selected from vinyl phosphonic acid, vinyl sulfonic acid, and 2-acrylamide-2-methylpropane sulfonic acid.

7. The electrolyte membrane according to claim 1, wherein the crosslinking agent has at least one radical-polymerizable functional group selected from with an acrylic group, a methacrylic group, a vinyl group, an allyl group, a methallyl group, a phenylvinyl group, a vinylether group, an acrylate group, and a methacrylate group.

8. A membrane electrode assembly comprising a cathode, an anode, and an electrolyte membrane located between the cathode and the anode,
wherein the electrolyte membrane is an electrolyte membrane according to claim 1.

9. A fuel cell including the membrane electrode assembly of claim 8.

10. A method of preparing an electrolyte membrane, the method comprising:
reacting, in an organic solvent, a fluoropolymer comprising a segment of the formula —CF₂—CF(M)CH₂—CF₂—, wherein M is selected from —CF₃—, —CF₂H—, —CFH₂—, and a combination thereof, with a low molecular weight basic compound having at least two amino groups to form a carbon-carbon double bond in the fluoropolymer; and
preparing a mixed solution comprising
a low molecular weight polymerizable proton conductor monomer comprising an acidic group having a dissociable proton and a polymerizable functional group, and
a crosslinking agent which crosslinks the low molecular weight polymerizable proton conductor monomer;
removing the organic solvent from the mixed solution to provide a precipitate;
performing a first crosslinking of the fluoropolymer with the low molecular weight basic compound contained in the precipitate to provide a crosslinked fluoropolymer;
co-polymerizing the low molecular weight polymerizable proton conductor contained in the precipitate with the crosslinking agent to provide a polymerized product of the low molecular weight proton conductor; and
performing a second crosslinking of the polymerized product of the low molecular weight proton conductor and the crosslinked fluoropolymer to provide an interpenetrating polymer network.

11. The method of preparing an electrolyte membrane according to claim 10, wherein the second crosslinking is performed by applying an electron beam, UV light, γ rays, and heat to the precipitate.

12. The method of preparing an electrolyte membrane according to claim 10, wherein the fluoropolymer is at least one selected from vinylidene fluoride-hexafluoropropylene copolymer and vinylidene fluoride-hexafluoropropylene-tetrafluoroethylene terpolymer.

13. The method of preparing an electrolyte membrane according to claim 10, wherein the low molecular weight basic compound is a heterocyclic compound having a nitrogen atom in the ring thereof.

14. The method of preparing an electrolyte membrane according to claim 10, wherein the acidic group of the low molecular weight polymerizable proton conductor is at least one selected from a phosphonic acidic group and a sulfonic acidic group.

15. The method of preparing an electrolyte membrane according to claim 10, wherein the low molecular weight polymerizable proton conductor is at least one selected from vinyl phosphonic acid, vinyl sulfonic acid, and 2-acrylamide-2-methylpropane sulfonic acid.

16. The method of preparing an electrolyte membrane according to claim 10, wherein the crosslinking agent is at least one radical-polymerizable functional group selected from an acrylic group, a methacrylic group, a vinyl group, an allyl group, a methallyl group, a phenylvinyl group, a vinylether group, an acrylate group, and a methacrylate group.

17. The method of claim 10, wherein the polymerizing and the second crosslinking are performed simultaneously.
